(19) United States
(12) Patent Application Publication
(10) Pub. No.: US 2019/0013626 A1
(43) Pub. Date: Jan. 10, 2019

(54) SHIELDED PLUG CONNECTION ASSEMBLY

(71) Applicant: Amphenol Tuchel Electronics GmbH, Heilbronn (DE)

(72) Inventors: Michael Grimm, Mosbach (DE); Robert Schädel, Eberstadt (DE)

(21) Appl. No.: 16/064,525

(22) PCT Filed: Dec. 5, 2016
(86) PCT No.: PCT/EP2016/079767

§ 371 Date: Jun. 21, 2018

(30) Foreign Application Priority Data
Dec. 21, 2015 (DE) 10 2015 122 471.2

(51) Int. Cl. H01R 13/6592; H01R 13/502; H01R 43/20

(52) U.S. Cl. CPC H01R 13/6592; H01R 43/20; H01R 13/502

(57) ABSTRACT

The invention relates to a plug connection assembly consisting of a round plug connector with a shielded cable which has a cable shield. The round plug connector consists of a housing which is at least partly made of metal, an insulating element which has contacts arranged therein, a directly adjacent tubular spacing element, an annular shield deflection which lies on the spacing element, and a cable clamp which receives the cable in the interior of the clamp and which comprises a shield support surface and a cable clamp cage connected to the shield support surface. The cable shield is first deflected at the shield deflection at an end-face shield deflection surface of the shield deflection and then folded back in the direction of the shield support surface of the cable clamp. Furthermore, the cable shield is attached to the shield support surface by means of a screw connection which produces the cable clamp in the direction of the shield deflection.

The invention relates to a plug connection assembly comprising a round plug connector and a shielded cable having preferably a plurality of insulated wires within.

The prior art discloses various plug connection assemblies for fitting a cable to a plug connector, preferably a round plug connector, the cable comprising a shielded line and a plurality of insulated wires, as also disclosed in DE 10 2011 120 211 A1. A considerable disadvantage comes to light during the assembly of said round plug connectors, since, when being installed in the housing, the partially preassembly round plug connectors cannot be retained in a fully immovable manner, and this renders installation difficult. In addition, there is a risk of the shielding means being folded over in an undefined manner, or being bent to the side, as a result of which individual wires of the cable shield can be sheared off when the plug connection assembly is being screw-connected. Furthermore, if the length of the cable shield is not precisely defined, there is a possibility of at least individual wires of the cable shield being pushed between a seal and a pressure-exerting surface of the seal, the sealing behavior being adversely affected as a result.

A wide variety of different embodiments of plug connection assembly for different fields and applications are known and in common use. Up until now, particularly the assembly and/or the uniform arrangement of the cable shield have given rise to considerable disadvantages, which results, for example, in impaired shielding in relation to undesirable interference signals. In addition, the time-consuming assembly of an entire plug-in connection system results in the overall costs of said plug connection assemblies increasing.

It is therefore the object of the invention to overcome said disadvantages and to provide an easy-to-assemble and improved solution for plug connection assemblies.

This object is achieved by the features of patent claim 1.

The invention therefore provides a plug connection assembly comprising a round plug connector having a shielded cable which has a cable shield, wherein the round plug connector comprises an at least partially metallic housing. The interior of the housing comprises a contact-carrying insulating body, a directly adjacent, tubular spacing element, an annular shield-deflecting means, which butts against the spacing element, and a cable-clamping means, which accommodates the cable in its interior. Said cable-clamping means comprises a shield-supporting surface and a cable-clamping cage connected thereto, wherein the cable shield is deflected at the shield-deflecting means in the first instance on an end-side shield-supporting surface and is folded back in the direction of the shield-supporting surface. The cable shield is made to butt against the shield-supporting surface by means of a screw connector, which the cable-clamping means in the direction of the shield-deflecting means. The cable shield of said round plug connector is cut, in the preassembled state, to a length which does not adversely affect the sealing of the round plug connector even in the installed state. The embodiment of the plug connection assembly here results in straightforward and quick assembly, without the shield behavior in relation to undesirable interference signals being adversely affected.

In a further advantageous embodiment of the invention, the insulating body is arranged directly at an end-side opening of the round plug connector. This makes it possible, starting from the insulating body, to provide for direct arrangement, in relation to a complete electronic connection assembly, at the opening of the round plug connector.

An advantageous configuration of the plug connection assembly is one in which the spacing element is formed in two or more parts and engages, preferably by means of a plurality of protrusions, in cutouts of the shield-deflecting means and secure and/or mount the shield-deflecting means in a rotationally fixed manner in relation to the spacing element. This means that the insulating body, spacing elements, shield-deflecting means and the cable-clamping means, which are plugged one inside the other, are retained in an immovable manner and can easily be installed in the housing of the round plug connector. The cutouts and protrusions of the insulating body, of the spacing element and of the shield-deflecting means provide for straightforward, tool-free assembly. Furthermore, the cutouts and protrusions clearly define the installation positions in relation to one another.

It is also advantageous if the spacing element of the round plug connector has cutouts, which interact with protrusions on the insulating body. The spacing-element cutouts, which are adapted to the protrusions of the insulating body, mean that the two components are retained in an immovable manner in relation to one another and can very easily be installed in the housing of the round plug connector without the individual components slipping in relation to one another.

In a further advantageous configuration of the invention, the insulating body, the tubular spacing elements, the shield-deflecting means and the cable-clamping means are plugged one inside the other in a plug-in direction (S), without any screw connection, by means of a straightforward plug-in assembly and are installed, or are in an installed state, together, in the form of a preassembled unit, in the housing of the round plug connector.

In one embodiment of the plug connection assembly, the length of the folded-over wires of the cable shield corresponds approximately to 70% 99% of the width, further preferably 90%-95%, of the shield-supporting surface of the cable-clamping means. One aspect for realizing a well-functioning round plug connector, also in terms of the long service life, involves protecting the inner connections of the round plug connector against environmental influences, for example moisture and dirt, which would adversely affect the properties of the round plug connector. For this reason, the cable shield should not extend, during assembly, into regions which are provided for sealing inner regions of the round plug connector. The length of the wires of the shielding means here should not exceed the width of the shield-supporting surface of the cable-clamping means, since otherwise there is a risk of parts of the shielding means reaching the sealing surface and of sealing of the round plug connector being compromised.

In a further development of the plug connection assembly the cable shield deflected preferably through 180° at the shield-deflecting means is pushed, or secured, against a clamping surface of the shield-supporting surface by the stop of the cable-clamping means. Shielded lines provide very good protection against undesirable interference signals, whereas the transitions between a cable and round plug connector often constitute critical regions. The arrangement of the round plug connector with a shield-deflecting means and the clamping surface of the cable-clamping means results in shield being provided against interference signals even at a transition between a round plug connector and a cable.

An advantageous embodiment of the plug connection assembly is one in which an elongate adjustment rib is provided integrally on an outer side of the spacing element, preferably beginning at an edge which in the plugged-together state butts directly against the insulating body, and define the installation position(s) of the spacing element and preferably of the insulating body connected thereto, and of the shield-deflecting means, in the housing. In the case of completely rotationally symmetrical components, there is a risk of the desired installation position not being found when preassembled parts are being installed in a housing, and therefore the use of an adjustment means, preferably of an adjustment rib, for installing the preassembled insulating bodies, the spacing elements and the shield-deflecting means together with the cable-sheathing cable-clamping means is a possible way of simplifying insertion into the housing to a considerable extent.

A further advantageous embodiment of the invention provides a plug connection assembly in which the cable-clamping means, plugged in the housing, is retained in the round plug connector by an intentionally releasable connection. In the case of said plug connection assembly, on the one hand, straightforward and quick assembly is realized by the plug-in insulating bodies, spacing elements and the shield-deflecting means in the interior of the housing. On the other hand, quick fastening of the cable and the cable-clamping means in the round plug connector is realized by way of a housing screw-connection means. The cable-clamping means arranged in the housing pushes the cable firmly against the cable-clamping cage, when the housing screw-connection means is being screw-connected to a central housing part, and prevents the cable from slipping out.

It is also advantageous if a first seal is arranged between a front part and a central part of the housing of the plug connection assembly, and a further seal is arranged between the central housing part and the cable-clamping means. In order to ensure that a plug connection assembly has a long service life, the protection of inner regions, preferably transitions between signal-carrying wires and contacts plugged into the insulating body, and/or the folded-over cable shield should be protected against dirt and moisture. It is the risk of oxidation in particular which results in increased instances of round plug connectors failing. For this reason, it is very advantageous to use seals between the housing and the current-carrying components of the round plug connector.

In particular, a seal between a front housing part and a central housing part and a further seal between the cable-clamping means and the the central housing part improve protection against incoming undesirable foreign particles and/or moisture, and therefore the electrical connections and lines of the round plug connector are better protected.

In a further advantageous embodiment of the invention, in the plugged-together state, the insulating body, the tubular spacing element, the shield-deflecting means and the cable-clamping means are retained in an immovable manner, preferably with clamping action against one another via clamping connections, prior to being installed in the housing.

An advantageous method for producing a plug connection assembly contains the following steps. In the first instance, the housing screw-connection means and the cable-clamping means is fitted over the cable and a lateral surface which encloses the cable shield is stripped. When the insulating body, the spacing elements and the cable-deflecting means are subsequently plugged together, the cable shield is spread open at the cable-deflecting means in a direction orthogonal to the plug-in direction, the cable shield therefore projecting radially outward. Once the cable shield has been cut to a predetermined length, while installation into the housing is taking place, the cable shield is folded back counter to the plug-in direction and is retained in an immovable manner between the shield-deflecting means and cable-clamping means.

In an advantageous configuration of the method for producing a plug connection assembly, the length of the cable shield is approximately between 70% and 99% of the width, and preferably between 90% and 95%, of the shield-supporting surface of the cable-clamping means. The length of the cable shield is determined, in particular, following the first folding-over operation at the shield-deflecting means. In this state, the wires of the cable shield project radially from the cable. Once the cable shield has been shortened to the desired length, it is folded back counter to the plug-in direction as installation continues.

Other advantageous developments of the invention are characterized in the dependent claims and will be presented in more detail hereinbelow, together with the description of the preferred embodiment of the invention, with reference to the figures, in which:

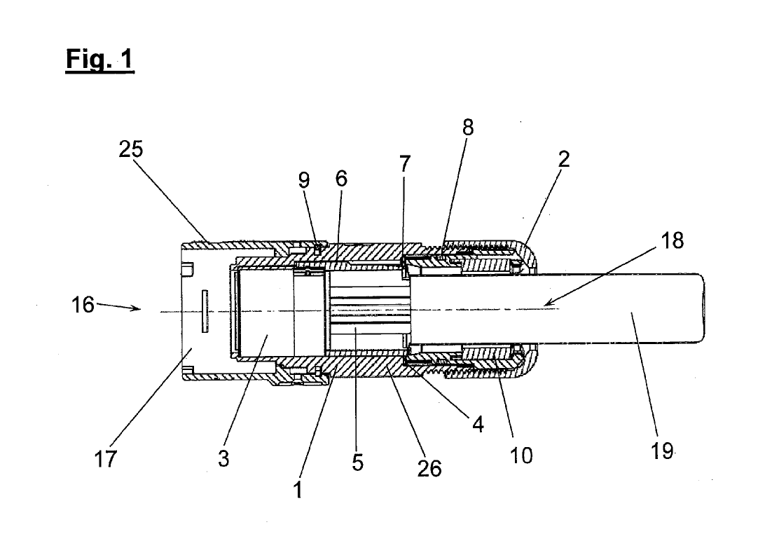

FIG. 1 shows a sectional view of a plug connection assembly comprising a round plug connector and a shielded cable;

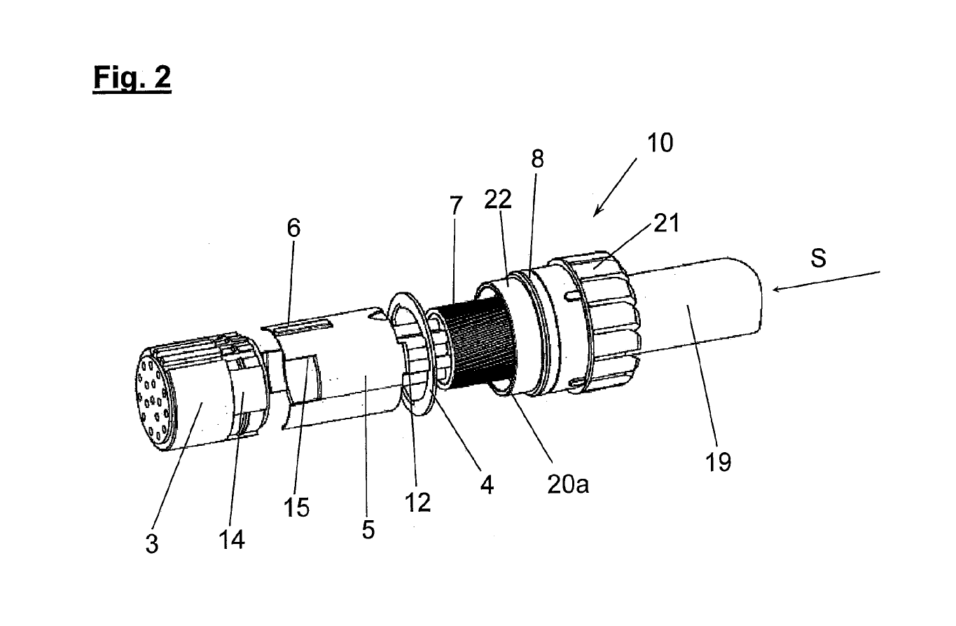

FIG. 2 shows a perspective illustration of the plug connection assembly from FIG. 1;

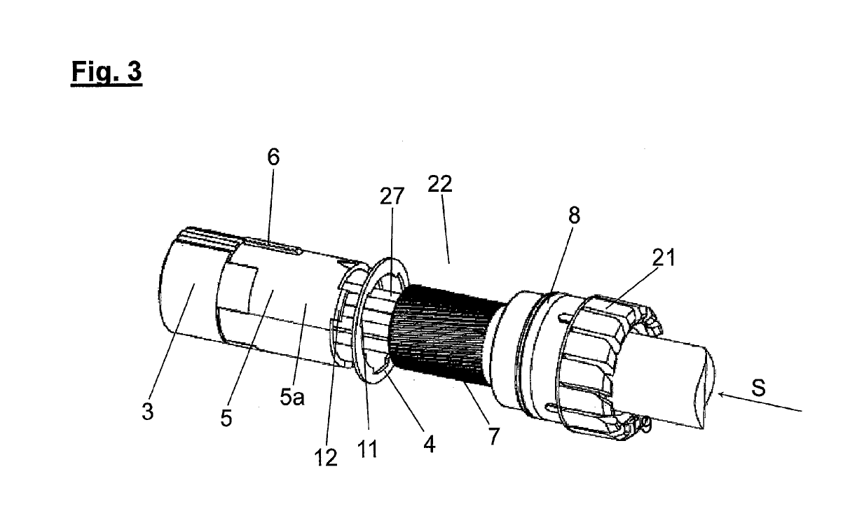

FIG. 3 shows a perspective illustration of the plug connection assembly from FIG. 1 having a plugged-together insulating body and spacing elements;

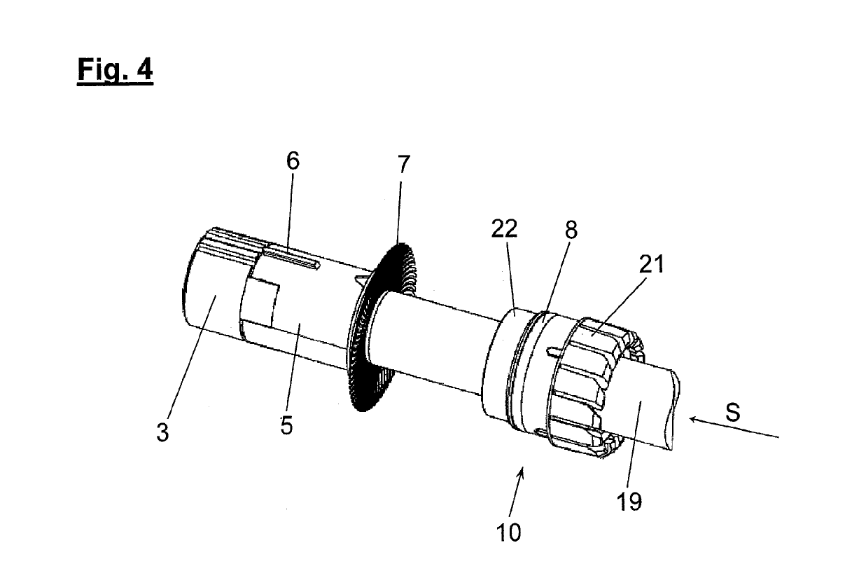

FIG. 4 shows a perspective illustration of the preassembled plug connection assembly from FIG. 1 in an intermediate assembly step; and

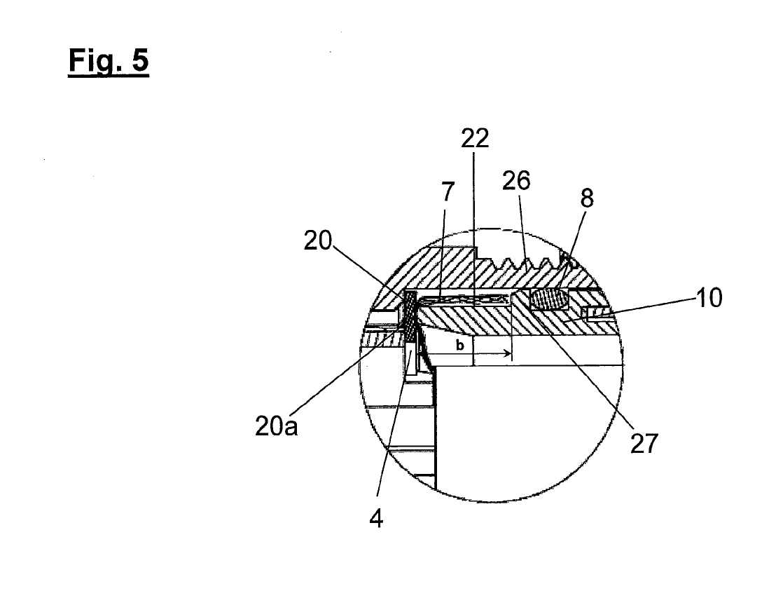

FIG. 5 shows a sectional view of a detail of the clamped-in cable shield of the plug connection assembly from FIG. 1.

FIG. 1 shows a sectional view of the plug connection assembly essentially comprising a round plug connector 17 and a cable 19 arranged thereon. Starting from an end-side opening 16 here, an insulating body 3, a multi-part spacing element 5, a shield-deflecting means 4 and a cable-clamping means 10, with a cable 19 accommodating in its interior, are arranged directly one beside the other. This preassembled unit is inserted firmly into the housing 1, which is made up of a front housing part 25, a central housing part 26 and a housing screw-connection means 2. The spacing element 5 here is preferably made of a non-metallic, electrically non-conductive material. This prevents possible short-circuits of projecting current-carrying wires, between the insulating body 3 and the shield-deflecting means 4 of the round plug connector 17. It is also possible to see the cable shield 7 folded back through preferably 180°.

FIG. 2 show a perspective illustration of individual, not-yet-assembled components of the plug connection assembly. FIG. 2 shows, in the form of an exploded drawing, the insulating body 3 having the protrusions 14, the tubular spacing element 5 having the cutouts 15, the adjustment rib 6 and the protrusions 12 of the spacing element, and also the shield-deflecting means 4 having the cutouts 11, which are shown in FIG. 3, and an opening 27, which is likewise shown in FIG. 3. FIG. 2 also shows the cable-clamping means 10 having the end-side clamping surface 20a, the shield-supporting surface 22, and the seal 8 with the cable-clamping cage 21.

FIG. 3 also shows a perspective illustration of the plug connection assembly corresponding essentially to FIG. 2, although the view has been rotated in relation to FIG. 2. In FIG. 3, the insulating body 3 and the spacing element 5 have already been plugged one inside the other. The plug-in positions are determined by the protrusions 14 of the insulating body 3, said protrusions being shown in FIG. 2, and the cutouts 15 of the multi-part spacing element 5, said cutouts likewise being shown in FIG. 2.

FIG. 4 shows a later assembly state of the individual components of the round plug connector 17 plugged together. In addition to the plugged-together components already shown in FIG. 3, in other words the insulating body 3 and the spacing element 5, the radially projecting cable shield 7 of the cable 19 is shown in the plugged-in state. When the plug connection assembly is being pushed together, the wires of the shielding means are uniformly spread open at the shield-deflecting means 4, or in addition by way of an auxiliary means.

FIG. 5 shows an enlarged sectional view of a detail of the cable shield 7 clamped in and folded back. It is possible to see here the cable shield 7, which is clamped in between the shield-supporting means 20 and the clamping surface 20a and has been folded over in the first instance through approximately 90° at the shield-deflecting means 4, and then through a further 90°, when the round plug connector 17 is being pushed together. In the first step, the wires of the cable shield 7 are folded over at the shield-deflecting means 4, project radially from the cable 19 and are folded back in full, following length adaptation, when the round plug connector is being pushed together. The cable shield is then folded over approximately through 180° in relation to the original direction. The length of an end portion of the cable shield 7 clamped in between the shield-supporting means 20 and clamping surface 20a corresponds approximately to a width b of the shield-supporting surface 22. A stop 27 of the cable shield 7 is arranged between the seal 8 and the shield-supporting surface 22.

The invention is not restricted in its execution to the preferred exemplary embodiments given above. Rather, a number of variants which make use of the solution presented, even in respect of embodiments of fundamentally different kinds, are conceivable. It is, for example, quite conceivable for materials used for the housing and/or individual components to differ from those used here.

1. A plug connection assembly, comprising:
a round plug connector having a shielded cable which has a cable shield, wherein the round plug connector comprises an at least partially metallic housing, a contact-carrying insulating body arranged therein, a tubular spacing element directly adjacent to the insulating body, an annular shield-deflecting means which butts against the spacing element, and a cable-clamping means which accommodates the cable in its interior and has a shield-supporting surface and a cable-clamping cage connected thereto,
wherein the cable shield is deflected at the shield-deflecting means in a first instance on an end-side shield-deflecting surface of the shield-deflecting means and is folded back in a second instance in the direction of the shield-supporting surface of the cable-clamping means, and
wherein the cable shield is made to butt against the shield-supporting surface by means of a screw connector such that clamping is caused via the cable-clamping means in the direction of the shield-deflecting means.

2. The plug connection assembly as claimed in claim 1, wherein the insulating body is arranged directly at an end-side opening of the round plug connector.

3. The plug connection assembly as claimed in claim 1, wherein the spacing element is formed in two or more parts and engages, by means of a plurality of protrusions, in cutouts of the shield-deflecting means and secure the shield-deflecting means in a rotationally fixed manner in relation to the spacing element.

4. The plug connection assembly as claimed in claim 1, wherein the spacing element has cutouts, which interact with protrusions on the insulating body.

5. The plug connection assembly as claimed in claim 1, wherein the insulating body, the tubular spacing element, the shield-deflecting means, and the cable-clamping means are plugged one inside the other in a plug-in direction without any screw connection, by means of straightforward plug-in assembly and are installed, or are in an installed state, together, in the form of a preassembled unit, in the housing of the round plug connector.

6. The plug connection assembly as claimed in claim 1, wherein the length of folded-over wires of the cable shield correspond approximately to 70% 99% of the width of the shield-supporting surface of the cable-clamping means.

7. The plug connection assembly as claimed in claim 1, wherein the cable shield is deflected through approximately 180° at the shield-deflecting means which is secured against a clamping surface of the shield-supporting surface by a stop of the cable-clamping means.

8. The plug connection assembly as claimed in claim 1, wherein an elongate adjustment rib is provided integrally on an outer side of the spacing element beginning at an edge which in a plugged-together state butts directly against the insulating body, and define the installation positions of the spacing element and of the insulating body connected thereto, and of the shield-deflecting means, in the housing.

9. The plug connection assembly as claimed in claim 1, wherein the cable-clamping means, plugged in the housing, is retained in the round plug connector by an intentionally releasable connection.

10. The plug connection assembly as claimed in claim 1, wherein a seal is arranged between a front part and a central part of the housing, and a seal is arranged between the central housing part and the cable-clamping means.

11. The plug connection assembly as claimed in claim 1, wherein in a plugged-together state, the insulating body, the tubular spacing element, the shield-deflecting means, and the cable-clamping means are retained in an immovable manner, with clamping action against one another via clamping connections, prior to being installed in the housing.

12. A method for producing a plug connection assembly as claimed in claim 1, having the following steps:
a. stripping the lateral surface of a shielded cable, said lateral surface enclosing the cable shield;
b. spreading open, and deflecting, the cable shield by plugging the cable in through the opening of the annular shield-deflecting means, the cable shield therefore projecting radially outwards;
c. cutting the shield to a predetermined length; and
d. folding back the shield counter to the plug-in direction.

13. The method as claimed in claim 12, wherein the predetermined length of the cable shield corresponds approximately to 70%-99% of the width of the shield-supporting surface of the cable-clamping means.
